(19) United States
(12) Patent Application Publication
(10) Pub. No.: US 2025/0284021 A1
(43) Pub. Date: Sep. 11, 2025

(54) MAINTAINING OPTIMAL FREQUENCY FOR NMR FORMATION EVALUATION USING MULTIPLE SENSITIVE VOLUMES

(71) Applicant: Halliburton Energy Services, Inc., Houston, TX (US)

(72) Inventors: Jie Yang, Houston, TX (US); Rebecca Jachmann, Houston, TX (US)

(73) Assignee: Halliburton Energy Services, Inc., Houston, TX (US)

(21) Appl. No.: 18/600,905

(22) Filed: Mar. 11, 2024

(51) Int. Cl. G01V 3/32; E21B 44/00; E21B 49/00; G01V 13/00

(52) U.S. Cl. CPC G01V 3/32; E21B 49/00; G01V 3/38; G01V 13/00; E21B 44/00

(57) ABSTRACT

A method of performing a nuclear magnetic resonance (NMR) measurement of a subterranean formation includes calibrating an NMR tool at a calibration formation operational frequency (ω_{gƒ@RT}) and a calibration borehole operational frequency (ω_{gbh@RT}) to determine calibration parameters for both the borehole and the formation sensitive volumes. The NMR tool is then operated in the borehole to determine, in the borehole sensitive volume, a downhole borehole operational frequency (ω_{gbh@T}) at which the downhole borehole sensitive volume is substantially unchanged from the calibration borehole sensitive volume. A processor determines a downhole formation operational frequency (ω_{gƒ@T}) at which the downhole formation sensitive volume is substantially unchanged from the calibration formation sensitive volume relative to the NMR tool based on ω_{gbh@T}, ω_{gbh@RT}, and ω_{gƒ@RT}. The processor also determines an optimal amplitude modulation (AMopt) for ω_{gƒ@T}. The NMR tool measures a property of the formation at ω_{gƒ@T} and AMopt.

### BACKGROUND

Nuclear magnetic resonance (NMR) is used as a tool in a number of different technology areas to investigate different types of mediums. NMR logging tools have long proven their value to formation evaluation. Petrophysical information can be derived from NMR measurements, such as, but not limited to petrophysical properties of fluid containing porous media. Various properties that can be measured using an NMR logging tool include pore size, porosity, porosity partitions, surface-to-volume ratio, formation permeability, fluid identification, and capillary pressure, which provide valuable information about the make-up of the geological formations and the amount of extractable hydrocarbons.

NMR measurements can occur when the medium is subjected to a static magnetic field, B₀, using a permanent magnet and to an oscillating magnetic field, B₁, using an antenna or antennae. When subjected to an applied static magnetic field, polarization of nuclear magnetic spins of the medium occurs based on the spin number of the medium and magnetic field strength. Applying an electromagnetic field with proper frequencies and directions to the medium in the static magnetic field, can perturb the polarization established by the static magnetic field in the sensitive volume. In optimal measurements, the static magnetic field and the perturbing field are perpendicular to each other. Collected responses received from the medium related to the total magnetization of nuclear spins in the medium, in response to these applied fields, can be used to investigate properties of the medium, and may provide imaging of the medium.

Generally, a permanent magnet's remnant field strength (B₀) is a function of temperature. Thus, when magnets are used in locations where temperatures vary widely, such as down hole, the preferred NMR activation frequency (which gives the best signal strength) may change with temperature. Additionally, the oscillating magnetic field (B₁) can be affected by several factors, including formation loading, the geometry of each coil, the positioning of coils in an antenna, the Q factor of each coil, the pulse amplitude, phase applied to each coil, etc. For example, when the electronic components of a transmitter experience a high temperature environment, pulse amplitude will vary due to the variation of the electronic properties of electronic components due to temperature. The performance variation of each transmitter depends on the specific electronic components and may differ for each transmitter, thus creating imperfections in pulses due to differences among the amplitudes of each pulse. To check and calibrate each of these factors can be a tedious and complicated task. Unfortunately, some of these factors can be significantly affected by environmental effects, especially under downhole conditions. This may increase the difficulty of calibrating each of the factors above.

### BRIEF DESCRIPTION OF THE DRAWINGS

Aspects of the disclosure are described with reference to the following figures, the features of which are not necessarily shown to scale. Some details of elements may not be shown or may be represented by conventional symbols in the interest of clarity and conciseness.

FIG. 1 illustrates an example logging while drilling environment, according to one or more embodiments.

FIG. 2 illustrates an example wireline logging environment, according to one or more embodiments.

FIG. 3 illustrates an example NMR tool, according to one or more embodiments.

FIG. 4 illustrates use of excitation tipping pulse and a sequence of recovery refocusing pulses, according to one or more embodiments.

FIG. 5 illustrates a CPMG sequence for a NMR tool calibration in which an intended excitation amplitude is varied, while an intended recovery amplitude and duration are held constant, according to one or more embodiments.

FIG. 6 illustrates a CPMG sequence for a NMR tool calibration using a recovery pulse at the end of the CPMG sequence, in accordance with one or more embodiments.

FIG. 7 illustrates a graph of signal amplitudes detected using an NMR tool as a function of amplitude modulation for different frequencies.

FIG. 8 illustrates a plot of a relationship between signal amplitude and frequency for the optimal amplitudes of the graph in FIG. 7.

FIG. 9 illustrates a plot of a relationship between amplitude modulation and frequency for the optimal amplitudes of the graph in FIG. 7.

FIG. 10 illustrates a plot of signal amplitudes and observed frequencies for different signal frequencies.

### DETAILED DESCRIPTION

The present disclosure describes an NMR tool and method of use that improves the accuracy of the NMR results by accounting for temperature dependency of the NMR signal. As part of the overall operation of the NMR tool, the tool also accounts for the effect of change in temperature downhole on the generation of the magnetic fields. In general, because the permanent magnets, for example Sm2Col7, used to generate the static magnetic field are temperature dependent, the static magnetic fields change under different temperature conditions. Therefore, the volume surrounding the tool under investigation and from which the NMR signal will be acquired, the sensitive volume, will change radially and axially if the same frequency is used to generate the electromagnetic signal under different temperature conditions. In general, the sensitive volume will contract radially and could also move in the downhole direction as the temperature surrounding the tool increases. These volumetric changes are not captured in temperature dependence conversion based on the Boltzmann factor: T_{log}/T_{RT}, where T_{log} is the temperature at which a well log is acquired and T_{RT} is the temperature at room temperature. Room temperature is whatever the standard temperature is set to for data analysis. The change in sensitive volume can lead to a departure in the Boltzmann correction factor applied to the signal to account for temperature change. However, if the frequency used to create the electromagnetic signal is changed based on temperature the basic radial and axial location of the volume of the sensitive volume could be substantially maintained. However, it is not obvious how to select the right frequency to maintain the same axial and radial location of the sensitive volume.

This disclosure describes systems and methods to account for the temperature dependency of the NMR signal. Starting with an equation for a permanent magnet's remnant field strength (B₀) with respect to radial distance from the magnet and temperature:

$${B}_{o} ( r , T ) = {B}_{o} ( r , {T}_{0} ) + \frac{\partial {B}_{o} ( r , {T}_{0} )}{\partial T} ( T - {T}_{0} ) + … \qquad ( Eq . 1 )$$

where r is the radial distance from the permanent magnet, T is the temperature, and T₀ is the reference temperature. Further,

$$\frac{Δ {B}_{o} ( r , T )}{{B}_{o} ( r , {T}_{0} )} = \frac{{B}_{o} ( r , T ) - {B}_{o} ( {r}_{o} , {T}_{0} )}{{B}_{o} ( r , {T}_{0} )} = \frac{1}{{B}_{o} ( r , {T}_{0} )} ( \frac{\partial {B}_{o} ( r , {T}_{0} )}{\partial T} ( T - {T}_{0} ) + … ) \approx g ( r , T ) \times ( T - {T}_{0} ) \qquad ( Eq . 2 )$$

Generally, g(r, T) is a function of both location and temperature. But when dipoles in magnets are assumed to have same temperature behavior, where g(r, T) is the fraction the field changes with a degree temperature change and is related to a magnet temperature coefficient k, where

$$k = g ( r , T ) \times 100 \qquad ( Eq . 3 )$$

In a sensitive volume where the area is fairly close to the permanent magnet and the formation is generally the same material, g(T) may be approximated as:

$$\frac{1}{{B}_{o} ( r , {T}_{0} )} ( \frac{\partial {B}_{o} ( r , {T}_{0} )}{\partial T} + … ) \approx \frac{1}{{B}_{o} ( {T}_{0} )} ( \frac{\partial {B}_{o} ( {T}_{0} )}{\partial T} + … ) = g ( T ) \qquad ( Eq . 4 )$$

which is independent of r. So at a radius r, the corresponding NMR frequency at temperature T is:

$${f}_{NMR} ( r , T ) = - γ {B}_{o} ( r , T ) = - γ {B}_{o} ( r , {T}_{0} ) [ 1 + \frac{1}{{B}_{o} ( r , {T}_{0} )} ( \frac{\partial {B}_{o} ( r , {T}_{0} )}{\partial T} ( T - {T}_{0} ) + … ) = {f}_{NMR} ( r , {T}_{0} ) ( 1 + g ( T ) \times ( T - {T}_{0} ) + … ) \qquad ( Eq . 5 )$$

For purposes of this disclosure, ƒ(T) is temperature conversion function and is a function of temperature that converts the NMR signal from a signal at one temperature to another temperature. Generally,

$$\frac{{f}_{NMR} ( r , {T}_{0} )}{{f}_{NMR} ( r , T )}$$

depends on location and can be measured in lab or through modeling. When reference r₀ is very close to r, linear approximation can be used as an example (higher order polynomial function can be used If needed). Also,

$$\frac{{f}_{NMR} ( r , {T}_{0} )}{{f}_{NMR} ( r , T )} \text{=≈} 1 + g ( {r}_{0} , T ) \times ( T - {T}_{0} ) + h ( {r}_{0} , T ) \times ( r - {r}_{0} ) \qquad ( Eq . 6 )$$

where g and h can be measured in a lab or determined using modeling.

In general, g(r, T) can be measured in realtime so that ƒ_{NMR} (r₀, T) can be determined, where r₀ is the effective radius of a location within the sensitive volume of the formation and g(r, T) is measured by performing NMR experiments using a borehole signal or modeling.

As described in more detail below, the transmission frequency for the formation volumes, V_{ƒi}, is changed with temperature such that ƒ(T) is set in a way that the signal reported is consistent after using a correction factor of either T_{log}/T_{RT} or T_{log}/T_{RT}×V_{c}, where V_{c} is a factor correcting for the small volume increase despite attempting to capture the NMR signal at the same radial volume. The methods can be used with or without taking into account the small volume changes due to the magnetic field temperature changes. The determination of whether the volume change is necessary is based on the magnetic field design. The signal dependency of the small volume change can be determined by modeling or by measurements in a lab or shop. The frequency selection, in order to avoid a dramatically changing sensitive volume, is aided by the use of a secondary sensitive volume, (herein V_{bhi}) that is fully located in the borehole.

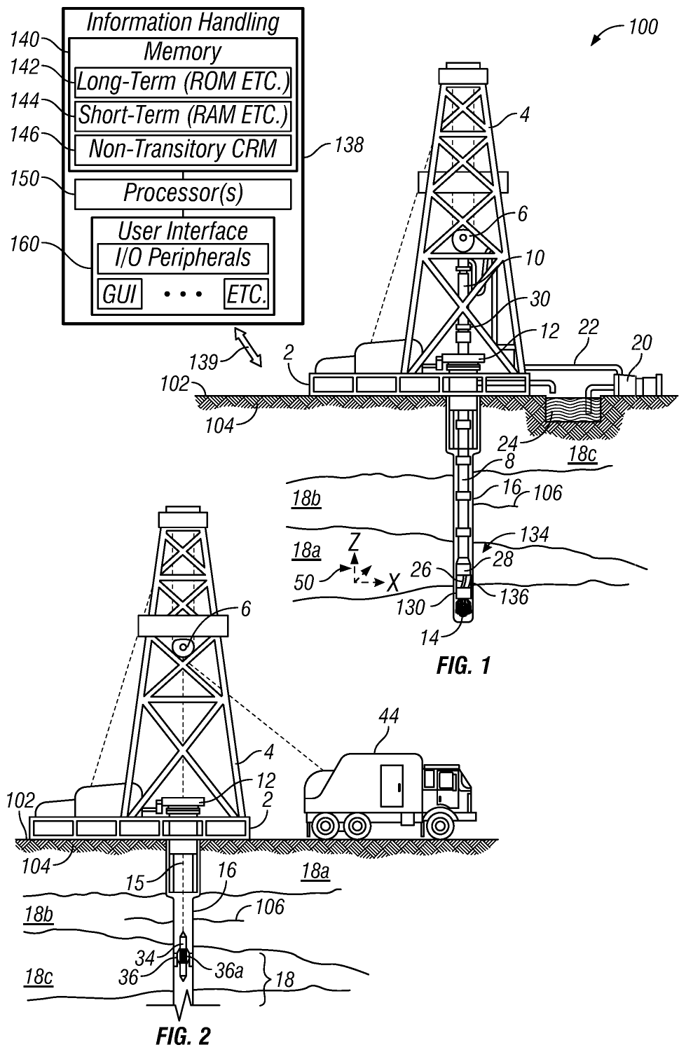

FIG. 1 is a diagram of a subterranean drilling system 100, according to aspects of the present disclosure. The drilling system 100 comprises a drilling platform 2 positioned at the surface 102. In the embodiment shown, the surface 102 comprises the top of a formation 104 containing one or more rock strata or layers 18 a-c, and the drilling platform 2 may be in contact with the surface 102. In other embodiments, such as in an offshore drilling operation, the surface 102 may be separated from the drilling platform 2 by a volume of water.

The drilling system 100 comprises a derrick 4 supported by the drilling platform 2 and having a traveling block 6 for raising and lowering a drill string 8. A kelly 10 may support the drill string 8 as it is lowered through a rotary table 12. A drill bit 14 may be coupled to the drill string 8 and driven by a downhole motor and/or rotation of the drill string 8 by the rotary table 12. As bit 14 rotates, it creates a borehole 16 that passes through one or more rock strata or layers 18. A pump 20 may circulate drilling fluid through a feed pipe 22 to kelly 10, downhole through the interior of drill string 8, through orifices in drill bit 14, back to the surface via the annulus around drill string 8, and into a retention pit 24. The drilling fluid transports cuttings from the borehole 16 into the pit 24 and aids in maintaining integrity or the borehole 16.

The drilling system 100 may comprise a bottom hole assembly (BHA) 134 coupled to the drill string 8 near the drill bit 14. The BHA 134 may comprise various downhole measurement tools and sensors 136 and LWD and MWD elements, including a nuclear magnetic resonance (“NMR”) tool 26. As will be described in detail below, the NMR tool 26 may measure a magnetic resonance response of the portion of the formation 104 surrounding the NMR tool 26, which may be used to determine, for example, the porosity and permeability of rock within the formation 104, and to identify the types of fluids trapped within pores of the rock within the formation 104.

The tools and sensors of the BHA 134 including the NMR tool 26 may be communicably coupled to a telemetry system 28. The telemetry system 28 may transfer measurements from the NMR tool 26 to a surface receiver 30 and/or to receive commands from the surface receiver 30. The telemetry system 28 may comprise a mud pulse telemetry system, and acoustic telemetry system, a wired communications system, a wireless communications system, or any other type of communications system that would be appreciated by one of ordinary skill in the art in view of this disclosure. In certain embodiments, some or all of the measurements taken at the NMR tool 26 may also be stored within the tool 26 or the telemetry system 28 for later retrieval at the surface 102.

The BHA 134 may further include a rotary steerable tool (RSS) 130 operable to provide directional control while drilling the borehole 16 from the surface 102 of the well site down into the formation 104. For example, the RSS 130 may be a “push the bit” type system that uses coordinated movement of pad pushers against the borehole 16 to urge the drill bit 14 in a particular direction. Alternatively, the RSS 130 may be a “point the bit” type system that can adjust the orientation of a drill bit axis relative a body of the RSS 130 in order to point the drill bit 14 in the desired direction. Directional drilling may result in any number of horizontal, vertical, slanted, curved, and other types of wellbore geometries and orientations to achieve a desired wellbore path.

In certain embodiments, the drilling system 100 may comprise an information handling system 138 positioned at the surface 102. The information handling system 138 may be communicably coupled to the surface receiver 30 and may receive measurements from the NMR tool 26 and/or transmit commands to the NMR tool 26 though the surface receiver 30. The information handling system 138 may also receive measurements from the NMR tool 26 when the tool 26 is retrieved at the surface 102. As will be described below, the information handling system 138 may process the measurements to determine certain characteristics of the formation 104, including the location and characteristics of fractures within the formation 104.

At various times during the drilling process, the drill string 8 may be removed from the borehole 16 as shown in FIG. 2. Once the drill string 8 has been removed, measurement/logging operations can be conducted using a wireline tool 34, i.e., an instrument that is suspended into the borehole 16 by a cable 15 having conductors for transporting power to the tool and telemetry from the tool body to the surface 102. The wireline tool 34 may include a NMR tool 36 having a similar configuration to the NMR tool 26. The NMR tool 36 may be communicatively coupled to the cable 15. A logging facility 44 (shown in FIG. 2 as a truck, although it may be any other structure) may collect measurements from the resistivity logging tool 36, and may include computing facilities (including, e.g., an information handling system) for controlling, processing, storing, and/or visualizing the measurements gathered by the NMR tool 36. The computing facilities may be communicatively coupled to the logging/measurement tool 36 by way of the cable 15. In certain embodiments, the information handling system 138 may serve as the computing facilities of the logging facility 44.

The information handling system 138 in direct or indirect communication with the BHA 134 may be used to gather, store, process, communicate, and analyze the data from the sensors 136 and other inputs and optionally to control the RSS 130 or other BHA components. The information handling system 138 may include various spatially separated components, which may include various above-ground components (e.g. at a surface of the well site and/or a remote location) and/or below-ground components, such as a downhole information handling subsystem. Such distributed or spatially separated components may be connected over a network or other suitable electronic communication medium. Thus, processing, storing, and/or analyzing of information may occur at different locations and times, and may occur partially downhole, partially at the surface 102 of the well site, and/or partially at a remote location, such as another well site or a remote data processing center. Sensor data and other information processed downhole may be transmitted to the surface 102 to be recorded, observed, and/or further analyzed at the surface or remote site. Additionally, information recorded on the information handling system 138 that may be disposed downhole may be stored until the RSS 130 may be brought to the surface 102. In some examples, the information handling system 138 may communicate with the RSS 130 through the telemetry system 28 (e.g., mud pulse, magnetic, acoustic, wired pipe, or combinations thereof) in real-time mode. The information handling system 138 may transmit information to the RSS 130 or BHA 134 and may receive as well as process information recorded by RSS 130 or BHA 134.

Generally, components of the information handling system 138 may include memory 140, one or more processor 150, and a user interface 160. Memory 140 may comprise any of a variety of electronic memory devices, such as one or more long-term storage device 142, one or more short-term storage device 144, and a non-transitory computer-readable media (“CRM”) 146. For the purposes of this disclosure, the CRM 146 may include any instrumentality or aggregation of instrumentalities that may retain data and/or instructions for a period of time. The CRM 146 may include, for example, without limitation, storage media such as a direct access storage device (e.g., a hard disk drive or floppy disk drive), a sequential access storage device (e.g., a tape disk drive), compact disk, CD-ROM, DVD, RAM, ROM, electrically erasable programmable read-only memory (EEPROM), and/or flash memory; as well as communications media such wires, optical fibers, microwaves, radio waves, and other electromagnetic and/or optical carriers; and/or any combination of the foregoing. The long-term memory 142 may be structured, for example, as read only memory (ROM), which is a type of non-volatile memory for which data is not readily modified after the manufacture of the memory device. The short-term memory 144 may be structured, for example, as random access memory (RAM), which in contrast to ROM or Flash, can be read and changed. For example, short-term memory may be used to temporarily store information such as computer executable instruction code (e.g., from software) and/or data from the sensors 136 for processing by a processor 150. The non-transitory CRM 146 may comprise a device or structure on which computer executable instructions, data, and other information may be stored in a non-transitory manner. The user interface 160 generally comprises one or more devices electronically connected or connectable to other components of the information handling system 138 for communicating information from or to a user (typically, a human user). The user interface 160 may include input/output (I/O) peripherals 162. Examples of peripherals for user input include a keyboard, mouse, stylus, track pad, touchscreen, smart goggles or glasses, a microphone, and biometric (e.g. fingerprint, retina, or facial recognition) sensors. Examples of peripherals that provide output for a user include a display, a speaker, a printer or other imaging device, a tactile feedback device, and smart goggles or glasses. Some of these peripherals provide both user input and user output.

The processor 150 may include a microprocessor or other suitable circuitry for processing information, such as for estimating, receiving and processing signals from the RSS 130 or other BHA components. The RSS 130 or information handling system may also include one or more additional components, such as analog-to-digital converter, filter and amplifier, among others, that may be used to process the measurements of the RSS 130 before they may be transmitted to surface 108. Alternatively, raw measurements from RSS 130 may be transmitted to surface 108.

Any suitable technique may be used for transmitting signals from RSS 130 to surface 108, including, but not limited to available telemetry e.g., mud pulse, magnetic, acoustic, wired pipe, or combinations thereof). While not illustrated, RSS 130 may include a telemetry subassembly that may transmit telemetry data to surface 108. At surface 108, pressure transducers (not shown) may convert the pressure signal into electrical signals for a digitizer (not illustrated). The digitizer may supply a digital form of the telemetry signals to information handling system 138 via a communication link 139, which may be a wired or wireless link. The telemetry data may be analyzed and processed by the information handling system 138. A communication link 139 (which may be wired or wireless, for example) may be provided that may transmit data from the RSS 130 or downhole information handling subsystem to components of the information handling system 138 at surface 102.

The information handling system 138 described above thus represents any of a broad range of different configurations. The information handling system 138, in any of its configurations, may be used in performing all or part of the methods and controlling all or part of the systems further described herein for implementing vibration failure analysis and mitigation. For example, the information handling system 138 may be used to process data from the sensors 136 and other inputs to analyze vibration and correlate vibration with tool failure and/or tool health. The correlations may then be used to guide decisions on tools in a tool fleet (in this example, a fleet of RSS tools) in terms of identifying or predicting failure, scheduling maintenance for tools, selecting tools for a job, and in some cases, in real-time vibration mitigation.

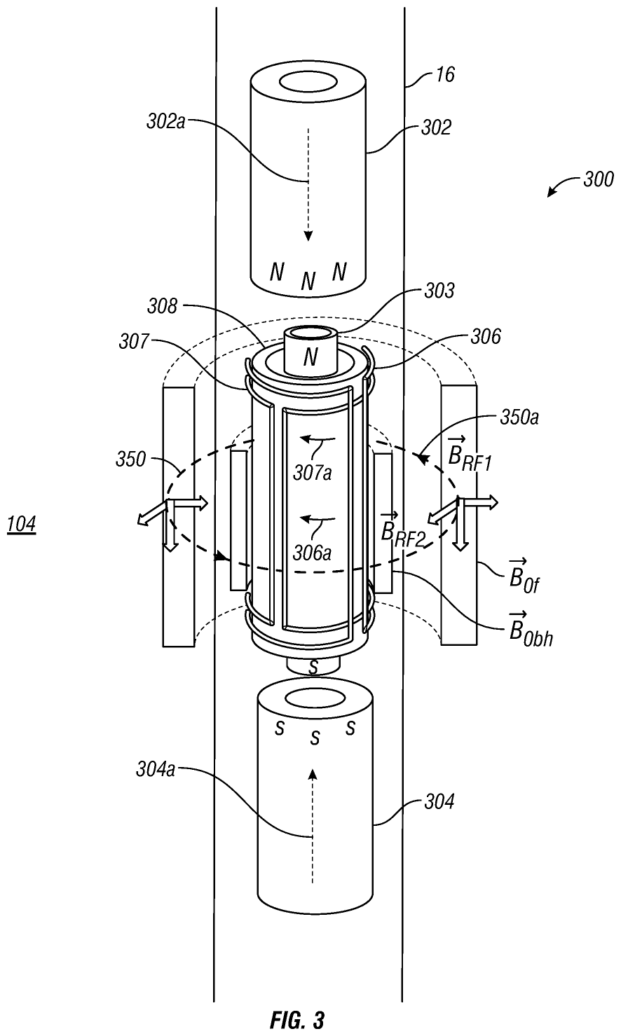

FIG. 3 is a diagram illustrating portions of an example NMR tool 300 in the borehole 16 and an associated eddy current 350 generated by the tool 300, according to aspects of the present disclosure. The tool 300 comprises magnetic field sources 302, 303, and 304 and antennae 306 and 307 capable of receiving and/or transmitting one or more electromagnetic signals to generate radio frequency (RF) fields, B_{RF1} and B_{RF2}. In the embodiment shown, the magnetic field sources 302, 303, and 304 comprise permanent magnets with a magnetic field orientation indicated by arrows 302a and 304a for magnets 302 and 304 respectfully. The antennae 306 and 307 may comprise solenoid-type antennae wrapped around a magnetically permeable material 308 that aids in focusing outward an electromagnetic field generated by the antennae 306 and 307. Other types and configurations of magnetic field sources and antennae are possible, including “transversal antennae” that generate electromagnetic fields perpendicular to the longitudinal axis of the tool 300.

In use, the magnetic field sources 302, 303, and 304 generate a static magnetic field, B₀, in the media surrounding the tool 300, such as in the borehole (designated as “bh”), B_{0bh}, and the formation (designated as “ƒ”), B_{0ƒ}, surrounding the tool 300 when the tool 300 is used in a drilling operation similar to the ones described above. Alternating current may be supplied to the antenna 306 in the direction indicated by arrow 306a, causing the antenna 306 to transmit an electromagnetic signal, B_{RF1}, into the media surrounding the tool 300 that is within the magnetic field B_{0ƒ}. Alternatively, antenna 307 may be similarly used. The electromagnetic signal causes an eddy current 350 to form in any electrically conductive media surrounding the tool 300. The eddy current 350 may flow around the antennae 306 and 307 following the shape of and in a plane generally parallel to the plane of the antennae 306 and 307, but in a direction opposite the flow of current through the antennae 306 and 307, as indicated by arrow 350a. In a downhole environment, the eddy current 350 may be generated in conductive fluids (e.g., formation fluids) surrounding the tool 300 in the formation 104 in the static magnetic field, B_{0ƒ}. The transmitted electromagnetic signals may be absorbed by the nuclei of atoms in the media subject to the magnetic field generated by the magnetic field sources 302, 303, 304 or the borehole. The oscillations of the coherent magnetic field, the magnetization, created by the spins have a specific resonance frequency which depends on the strength of the magnetic field and the magnetic properties of the isotope of the atoms. The antennae 306 and 307 or another antenna in the tool may measure the magnetic resonance response of the excited magnetization within the formation to facilitate a determination of certain characteristic of the surrounding formation. These characteristics are commonly the relaxation rates of the magnetization to return to thermal equilibrium.

An electromagnetic signal, B_{RF2}, may also be transmitted from the antenna 306 to cause an eddy current 350 to form in any electrically conductive media surrounding the tool 300. In a downhole environment, the eddy current 350 may be generated in conductive fluids (e.g., drilling fluids) surrounding the tool 300 in the borehole 16 in the static magnetic field, B_{0bh}. Alternatively, alternating current may be supplied to the antenna 307 in the direction indicated by arrow 307a, causing the antenna 307 to transmit the electromagnetic signal, B_{RF2}, into the media surrounding the tool 300 in the borehole 16.

In operation of the tool 300, nuclear magnetic resonance (“NMR”) measurements are created by the oscillation of excited nuclear magnetic spins in the transverse plane, that is, the direction perpendicular to the magnetic field. This oscillation eventually dies out and the equilibrium magnetization returns. The return process is referred to as longitudinal relaxation. The time constant, T1, for nuclei to return to their equilibrium magnetization, M0, is called the longitudinal relaxation time or the spin lattice relaxation time. The magnetization dephasing, that is losing coherence, along the transverse plane is given by the time constant T2 and is called the spin-spin relaxation time. The loss of phase coherence can be caused by several factors including interactions between spins, electrons, or magnetic gradients.

A widely used NMR measurement technique, designed by Carr, Purcell, Meiboom, and Gill and, hence, referred to as CPMG, uses a sequence of radio frequency pulses to produce spin echoes and counteract dephasing of the magnetization in the medium investigated. In the CPMG sequence, an initial pulse, commonly a 90° pulse, the excitation pulse, can be generated using an antennae coil or multiple antennae and applied to tip the polarization into a plane perpendicular to the static magnetic field. To counter dephasing due to magnetic inhomogeneities, another pulse, a recovery pulse, commonly a 180° or other angle excitation tipping pulse, is applied to return to phase, which produces a signal called an echo from the medium. Yet, after each return to phase, dephasing begins and another recovery pulse is applied for rephasing. Rephasing or refocusing is repeated many times in the CPMG sequence, followed by measuring each echo. The echo magnitude decreases with time due to a number of irreversible relaxation mechanisms. The CPMG sequence can have any number of echoes, where the time between each echo can be relatively short, for example, of the order of 0.5 ms or less or as long as 12 ms is used.

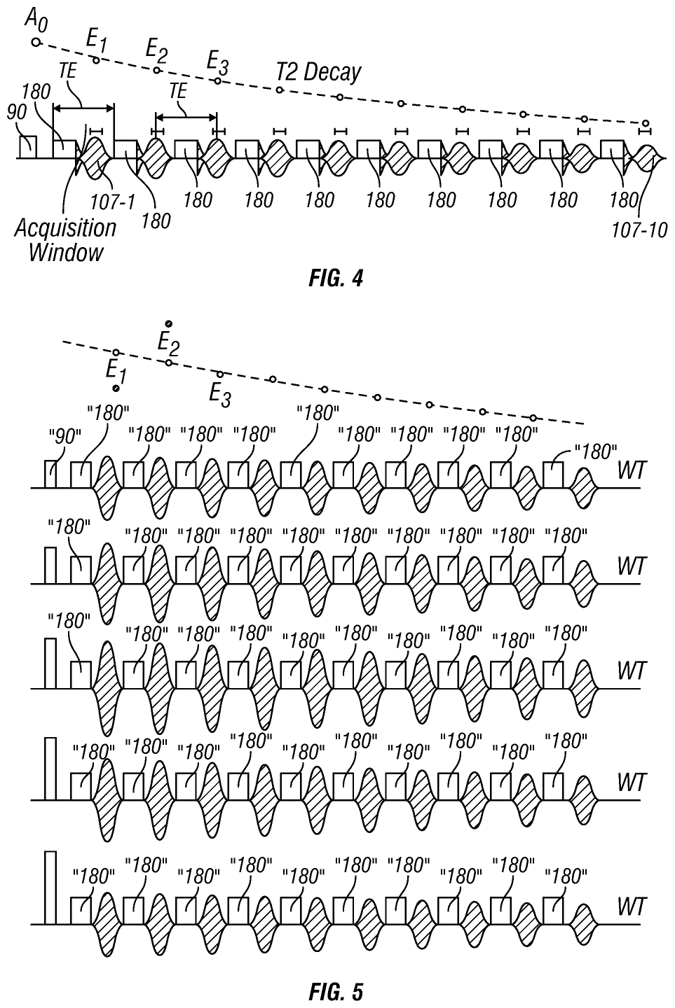

FIG. 4 illustrates use of an excitation tipping pulse and a sequence of recovery refocusing pulses. In this sequence, the ten recovery refocusing pulses cause ten echoes 107-1 . . . 107-10, where the peak amplitudes of the echoes are equally spaced apart by a peak-to-peak time distance, TE, that corresponds to the equally spaced apart time distances of the recovery refocusing pulses. Also indicated are an acquisition window for capturing the signal of an echo, a first echo E1, a second echo E2, and A0. A0 is the constructed amplitude of the echo train at time zero. A0 can be calculated by using an exponential decay fitting curve determined from a third (or more) echo E3 to the last echo. E1 and E2 can be included if they are corrected. These echoes decay according to the T2 of the medium. Once the nuclear spin population is fully recovered for the sequence, the medium can be probed again by another sequence.

T2 is related to loss of phase coherence that occurs among spins, which can be caused by several factors. For example, magnetic field gradients in pores lead to different decay rates. Thereby different pore sizes in the formation produce a distribution of T2 values, which is shown in the conversion of spin-echo decay data of NMR measurements. This distribution represents a “most likely” distribution of T2 values that produce the echo train of the measurement. This distribution can be correlated with a pore size distribution when the rock is 100% water saturated. However, if hydrocarbons are present, the T2 distribution will be altered depending on the hydrocarbon type, viscosity, and saturation. With proper calibration and account for hydrogen index of the fluids in the pore space, the area under a T2 distribution curve is equal to total porosity. More precision in the evaluation of NMR data may be aided with increased acquisition of data from multiple NMR measurements.

An excitation pulse has the function of tipping the magnetization into the transverse plane, while a recovery pulse has the function of inverting the magnetization. A pulse has two characterizations: length in time, called duration, and amplitude. The pulse can be modulated by frequency and amplitude, which gives it a density. These two characterizations play off each other. An excitation pulse can be achieved by having the correct integrated amplitude. When a pulse intended to excite and tip a sample 90° degrees has the wrong integration, it is no longer a true 90° pulse. When a pulse intended to excite and tip a sample 90° degrees is not a true 90° pulse, the NMR signal is reduced. Therefore, to obtain the best signal-to-noise ratio (SNR), it is important that the intended excitation pulse has a correct shape, both in duration and density, to flip the magnetization by 90° degrees, as well as the intended 180° having a correct shape. Herein, pulses with certain intent that are not achieving their desired intent are designated by quotation marks. For example, “90” stands for a pulse which tips magnetization near 90° but not actually 90 degrees. Also, “180” stands for a pulse intending to be 180°, but the tipping angle is either larger or smaller than 180°. In general, the recovery pulse has twice the duration of the excitation pulse with the same amplitude. However, the recovery pulse need not be defined in this manner and can be calibrated separately from an excitation pulse. While 90 pulses and 180 pulse are ideal, there are circumstances such as energy conservation operation where the tool would be operated on purpose not using an excitation pulse which is a “90” pulse and/or a “180” pulse. The most common of these operations would be to use a “90” pulse with a “135” pulse, but any combination might be used. Though the process is shown where the excitation pulse is a “90” pulse and the recovery pulse is a “180” pulse these are stand ins for any tipping angle.

As part of the overall operation of the tool 300, the tool 300 accounts for the effect of change in temperature downhole on the generation of the magnetic fields. To begin, a relational understanding of the operational frequency of the sensitive formation volumes, V_{ƒ}, and the sensitive borehole volumes, V_{bh}, where the minimal number of volumes for each is one, is understood from the basic understanding of calculating a magnetic field.

Examining the magnetic field at two points illustrates the relationship. A first point in the sensitive volume of the formation, P_{ƒi}, is selected. The magnetic field strength for this point at room temperature (“RT”) is B_{0ƒi@RT} and the NMR test signal frequency will be:

$${ω}_{fRT} = - γ {B}_{0 fi @ RT} \qquad ( Eq . 7 )$$

where γ is the gyromagnetic ratio of the sample being measured. For example, the sample could include hydrogen. The magnetic field will change with a temperature coefficient of k. The temperature coefficient captures the gain or loss of magnetic field over a certain temperature range. The temperature coefficient of a magnet made of Sm2Co17 for example can be −0.04% per degree Celsius, or per degree Kelvin. The NMR test signal frequency at a second temperature, T, which may be a temperature downhole in the borehole, e.g., T_{log}, which has a difference from RT of ΔT would then be:

$${ω}_{fT} = - γ {B}_{0 fi @ RT} ( 1 + g ( {r}_{0} , T ) \times Δ T + h ( {r}_{0} , T ) \times ( r - {r}_{0} ) ) \qquad ( Eq . 8 )$$

where ω_{ƒT} is in rad/s.

A second point in the sensitive volume of the borehole, P_{bhi}, is then selected. The magnetic field strength for this point at RT is B_{0bhi@RT} and the NMR test signal frequency will be

$${ω}_{bhRT} = - γ {B}_{0 bhi @ RT} \qquad ( Eq . 9 )$$

The magnetic field will change with the temperature coefficient k. The temperature coefficient captures the gain or loss of magnetic field over a certain temperature range. The NMR frequency at a second temperature, T, which has a difference from RT of ΔT would thus be:

$${ω}_{bhT} = - γ {B}_{0 bhi @ RT} \times ( 1 + g ( {r}_{0} , T ) \times Δ T + h ( {r}_{0} , T ) \times ( {r}_{bh} - {r}_{0} ) ) \qquad ( Eq . 10 )$$

where r_{bh} is effective borehole radius.

This also means

$${ω}_{fT} = {ω}_{fRT} \times ( 1 + g ( {r}_{0} , T ) \times Δ T + h ( {r}_{0} , T ) \times ( {r}_{f} - {r}_{0} ) ) \qquad ( Eq . 11 )$$

where r_{ƒ} is effective formation radius and

$${ω}_{bhT} = {ω}_{bhRT} \times ( 1 + g ( {r}_{0} , T ) \times Δ T + h ( {r}_{0} , T ) \times ( {r}_{bh} - {r}_{0} ) ) \qquad ( Eq . 12 )$$

The two frequencies have the same multiplier to find the new frequency at temperature T. This indicates that if the operational frequency to keep the sensitive volume at temperature T the same as it was at RT of the borehole volume is known then any operational frequency to maintain the volume geometry of sensitive volumes in the formation are also known. In other words, if every frequency needed for the sensitive volumes of V_{gbhi} are known and the RT frequency for V_{gƒi} is known, the frequencies for V_{gƒi}(T) are also known.

The change in the magnetic field can be measured and is given the value k. However, the magnet for the downhole NMR tool may include a permeable material that can change non-linearly in the range of frequency use. The change due to the permeable material is captured in its own function. This means that g(T) is a function of the permeability and the magnet material. With the magnet assembly including the permeable material it can thus be necessary to do an active calibration to track the geometrically same volume over temperature.

For the purposes of this disclosure, the sensitive volume that is substantially the same at temperature or at room temperature (“RT”) is designated by adding a g to the volume designation, e. g, V_{gƒi} or V_{gbhi}, since it is geometrically in the same position, but different in terms of frequency. Also, for the purposes of this disclosure, bh designates that the NMR sensitive volume falls geometrically where the signal is from the borehole.

The properties that can be measured using an NMR logging tool such as tool 300 may be reported in porosity units, PU, which require a conversion calculation from the inherent non-descript units of the tool 300, engineering units, EU. Further, the reported NMR signal, designated S_{reported} herein, may be in the form of a single porosity, of that of multiple porosities such as macro, meso, and micro, or an entire spectrum. In any case the conversion will be the same where the S_{reported} is a single value or a list of many values. In the case of many values, the calculation is done for each value in EU units to those of porosity. Although the delivered answer is designated S_{reported} herein, S_{reported} could be given any symbol. The desired units for S_{reported} are porosity units (PU). Porosity units signify the open space for fluid to fill in a space. For example, porosity is the liquid fill portion of a rock. The general form for the conversion calculation is as such:

$${S}_{reported} = {S}_{fi @ T} \times \frac{Known PU}{{S}_{fi fluid ( EU @ RT )}} \times f ( T ) \qquad ( Eq . 13 )$$

where S_{ƒi,@T} is the signal acquired from the formation by the NMR tool 300 during a logging run at temperature, T, where i designates the specific band or frequency used for that signal, ƒ designates that the signal came from the formation. S_{fi fluid (EU@ RT}) is the signal acquired by the NMR tool 300 during the calibration from the representative formation sensitive volume ƒ, frequency i, and using fluid, which has known porosity. For example, a common fluid for calibration is water, which has a known PU of 100 PU.

The logging run could be while drilling or wireline, or tubbing through bit, but it is not limited to those cases. The primary sensitive volume(s) in the formation is designated as V_{ƒi}. The tool 300 is not limited to only one sensitive volume in the formation and the following methods can be used for any number of volumes. If there are more sensitive volumes in the formation, they can be denoted with counting number, operational frequency, or any other naming scheme desired.

For purposes of this disclosure, S_{fi water(EU@ RT)} is the NMR signal measured in EU units in a lab or shop condition for the condition considered to be 100 PU. The condition for 100 PU is typically a tank of water at room temperature (RT). The lab or shop is anywhere which is not under the ground which is set up to take measurement from the tool. This set up typically requires a water tank, Faraday cage, proper grounding, and the tool but other set ups may be used. Further, RT is whatever temperature the signal is to be for all tools being compared. For example, the RT could be 25° C. (298.15 K). In another case it might be 70° F. (294.261 K). Whatever the RT temperature, the temperature needs to be converted to Kelvin for the calculations described herein.

For purposes of this disclosure, ƒ(T) is a function of temperature that converts the NMR signal from a signal at one temperature to another temperature as described in more detail herein. The temperature conversion function ƒ(T) is used because the NMR answer product should be independent of temperature. As is known, NMR measurements are dependent on temperature due to the temperature directly affecting the amount of possible polarization. However, a differing polarization does not change the amount of porosity in a rock formation so the NMR answer product should be independent of temperature. The standard ƒ(T) used is T_{log}/T_{RT}. This conversion function is a first order approximation from the Boltzmann equation when a Taylor expansion is used. For this conversion function to be valid the formation temperature, tool temperature, and mud temperature must all be the same, otherwise the formation temperature used for ƒ(T) is unknown.

Since ƒ(T) alone may not adequately account for changes in magnetic field due to temperature, to account for the temperature dependency of the NMR signal, a first embodiment method assumes there is no change in the sensitive volume despite the magnetic field gradient lowering as temperature rises. In general, the “no volume correction” method determines a frequency to be used for the RF pulse sent out into the formation at a downhole temperature that matches a measured signal at room temperature to a theoretical room temperature signal according to:

$${S}_{gbhi @ RT} = {S}_{bhi , @ T , @ F} \times f ( T ) \qquad ( Eq . 14 )$$

$$where$$

$$f ( T ) = {T}_{log} / {T}_{RT} \qquad ( Eq . 15 )$$

S_{gbhi@RT} is the signal received by the NMR tool 300 from measurements in the borehole bh sensitive volume for a frequency i, at room temperature RT that is equal to the signal that is received by the tool 300, S_{bhi,@T,@F}, at borehole temperature T and borehole pressure F that is corrected by the conversion function ƒ(T).

To begin, calibration of the tool 300 in the lab is performed. To do so, in a first mode where the NMR tool has borehole measurement capabilities, formation sensitive volume operational frequencies and borehole sensitive volume operational frequencies of the tool 300 are determined or selected using any suitable method. For example, the frequencies can be selected by modeling the magnetic fields B_{0ƒ} and B_{0bh}, measuring the magnetic fields with a gauss meter, or even by moving a small tank around to find an optimal returned signal. For example, a frequency may be selected based on either a theoretical or measured magnetic field. The volume extent of the magnetic fields in space is determined by the bandwidth (BW) of the signal pulse. To a first approximation, the bandwidth is the inverse of the pulse length. The magnetic field map can be converted to and from the frequency domain to that of magnetic strength such as tesla, ω=−γB₀. The magnetic field is changed from gauss or tesla to frequency to create a spatial frequency map. The sensitive volume's radial and axial locations in relation to the tool for a given frequency is substantially then where in space frequency is between ω₀±½ BW. Here ω₀ is the center frequency of the pulse, or the operational frequency. The frequencies included in a particular pulse maybe more accurately accessed if a pulse is measured in time. By performing a Fourier transform from the time domain of a pulse to the frequency domain the exact frequencies included in the pulse are known. The frequencies can then be plotted on a spatial frequency map. The operational frequencies that operate in the borehole and formation can then be determined based on the magnetic field map and the intended pulses. If the field map has a particular structure that is identifiable by the NMR signal, such as a saddle point, where that spatial volume will have maximal signal the NMR signal can be used to alternatively pick the operational frequency.

Calibration is then performed for every selected formation sensitive volume operational frequency to determine S_{gƒi fluid (EU@ RT}), the optimal AMfexc and AMfrec, and the global AMoptgf@RT for each frequency and each pulse duration which could be used downhole in a logging operation. The calibration may find a preferred frequency or have a selected frequency. As explained above, S_{gƒi fluid (EU@ RT)} is the signal received by the tool 300 from the formation ƒ sensitive volume at a frequency i for a fluid, e.g., calibration fluid, in engineering units EU at room temperature RT. AMfexc and AMfrec are the amplitude of the excitation and recovery pulses as described above. The calibration process for the formation sequences are performed on a tank full of a known substance and how the signal will relate to 100 PU. The fluid might be water doped with a doping agent, e.g., magnesium chloride, to reduce the wait time needed to reach full polarization. The fluid might be water, or it might be an oil. Any suitable method for calibrating the tool 300 can then be performed. For example, the calibration may use either a T₁ sequence or a T₂ sequence according to the CPMG technique described above. The calibration can be done with the same pulse sequence which will be run downhole, or different pulse sequences can be used.

The calibration process will identify an optimal excitation pulse that can be considered a 90 pulse. The excitation pulse calibration may constitute varying the amplitude of the pulse. The designator of the pulse which is best suited to be called an excitation pulse may give the highest return signal. If a series of pulses with the same duration as the excitation pulse is used, for example two with a small time in between, followed by a recovery pulse, the signal being searched for might be minimal instead of maximal. There are many schemes for calibrating both the recovery pulse and the excitation pulse that may be used. The sequence used on the formation may also include pulses which are neither 90 or 180 pulses, but are still excitation, nullification, or recovery pulses.

As stated, any suitable method for calibrating the tool 300 can then be performed to determine S_{gƒi fluid (EU@ RT)}, AMfexc and AMfrec, and AMoptgf@RT for each frequency and each pulse duration. For example, a method of calibrating for optimal 90° flip in an NMR logging tool can include running CPMG technique sequences as shown in FIG. 5, in which amplitude is varied and the resulting A0 values or echo amplitudes are compared. Alternatively, variation of pulse duration can be used.

The CPMG sequence is followed by a wait time, WT. This wait time is usually about 5 times the T1 of the solution. In pure water, the WT can be on the order of 12 to 15 seconds. Usually, water is doped with a doping agent, lowering T1, in the calibration tank, which can cause additional error and problems. Other substances, for example, glycerol and peanut oil, can also be used to calibrate an NMR tool.

In these calibration processes, correction for the first two echoes (E1 and E2) of the pulse train can also be found. A restriction on the calibration sample in these processes is that it has NMR active nuclei for the experiment. There are also limitations on how small the T2 can practically be. The hydrogen index (“HI”) of the calibration sample is also a useful piece of information.

The calibrations for the excitation and recovery pulses are performed iteratively in their respective current methods. Either the excitation calibration or the recovery calibration can be performed first. FIG. 5 shows an example CPMG sequence for a tool calibration in which an intended excitation amplitude is varied, while an intended recovery length and amplitude are held constant. A “180” pulse length and amplitude are chosen and held constant, while the “90” pulse is incremented through many different amplitudes. Having “90” pulse amplitudes varied, while “180” pulse amplitude is held constant provides a first stage. A best “90” from this first stage is then determined by determining the maximized A0 or echo amplitude. The best “90” may be determined by curve fitting to find the highest A0 or echo values.

The determined best excitation or “90” pulse is then used in a sequence, where the “90” pulse properties are held constant and the recovery or “180” pulses are varied. Varying the “180” pulse amplitude, while “90” pulse amplitude is held constant, provides a second stage to the procedure. A best “180” pulse is then determined by determining the maximized A0 or echo amplitude. The best “180” pulse may be determined by curve fitting to find the highest A0 or echo values. As noted above, stage 2 may be conducted to determine a best “90” pulse with stage 1 conducted to determine a best “180” pulse. The best AMfexc and AMfrec, may then be used to determine the AMoptgf@RT for each frequency as the optimized ratio of AMfexc and AMfrec for each frequency.

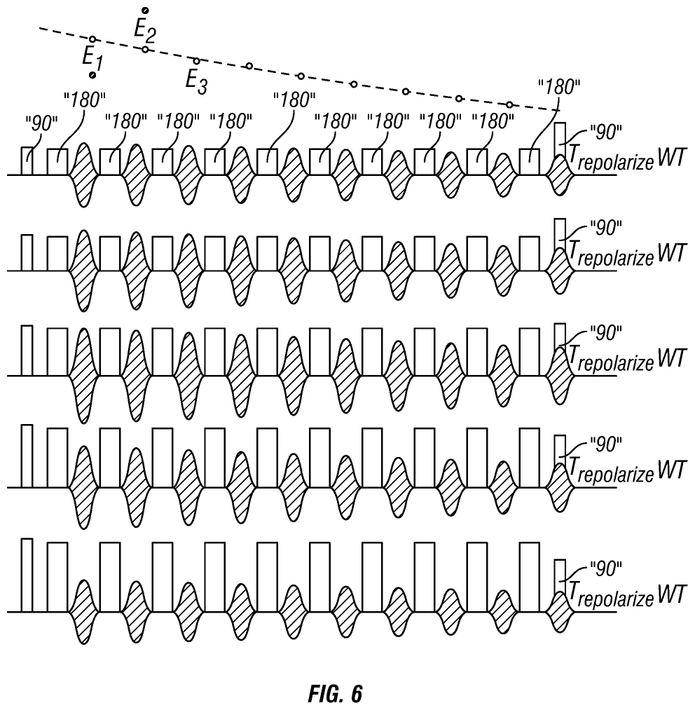

Alternatively, a calibration process may be performed to find an optimal magnetization excitation tipping pulse and an optimal magnetization recovery tipping pulse. FIG. 6 shows such an example embodiment of a calibration process using a recovery pulse. In various embodiments, a recovery pulse is used at the end of the calibration sequence. A CPMG sequence can be implemented as a calibration sequence for tool calibration with a recovery pulse added. This recovery pulse provides repolarization, which can reduce the needed WT for full recovery. The recovery can be realized as a 90-degree pulse applied at the time that corresponds to the maximum amplitude of the echo that would follow the last refocusing pulse of the sequence. The recovery pulse can be applied having the opposite orientation as the tipping pulse. This enhancement to the measurement process can be on the order of a few milliseconds to near the full WT depending on the number of echoes used in the sequence. Fewer echoes allow for shorter WTs. Calibration can be determined by comparing A0 values from sequences with different “90”/“180” amplitudes. Any number of “180” pulses may be used. Again, the best AMfexc and AMfrec, may then be used to determine the AMoptgf@RT for each frequency as the optimized ratio of AMfexc and AMfrec for each frequency.

In addition to performing calibration for each of the formation operational frequencies, calibration is also performed for each of the selected borehole operational frequencies to determine S_{gbhi fluid (EU@ RT)} AMfexc, and AMfrec, and AMoptgbh@RT for each frequency and each pulse duration which could be used downhole in a logging operation. However, in a second mode for an NMR tool 300 without borehole measurement capabilities, calibration at borehole operational frequencies need not be performed. The calibration may find a preferred frequency or have a selected frequency. Here, S_{gbhi fluid (EU@ RT)} is the signal received by the tool 300 from the borehole bh sensitive volume at a frequency i for a fluid that has similar properties to mud fluid used in drilling in engineering units EU at room temperature RT, which can be used as a conversion factor to go from EU to PU. AMfexc and AMfrec are the amplitude of the excitation and recovery pulses identified as described above. For each volume of interest in the borehole, where more than one volume may increase the accuracy of selecting the formation's volume frequency, AMbhexc@T, and AMbhrec@T may be determined on either a tank of fluid (like doped water) or a tank of the specific mud being used in the borehole. The optimal AMbhexc@RT and AMbhrec@RT results should be independent of the fluid being measured for the same volume location and pulse widths. However, S_{gbhi fluid (EU@ RT)} should be measured on the same mud that will be used during the formation logging. To determine S_{gbhi fluid (EU@ RT)}, the mud is placed in a calibration tank. The total calibration signal at time zero (A0bh) for each calibration borehole operational frequency is also determined for the fluid. This can be thought of as measuring the mud's porosity, but the units will be kept in EU as the variable indicates to result in A0bh(EU@RT). Though the data for S_{gbhi fluid (EU@ RT)} itself could be used for analysis, a single value such as total porosity may also be used. AMoptgbh@RT is also determined for each frequency in a similar manner as described above for AMoptgf@RT.

The result of the calibration gives S_{gƒi fluid (EU@ RT)}, AMfexc and AMfrec, and AMoptgbh@RT for each formation frequency and each pulse duration used in an activation which could be used during downhole logging. If enough frequencies or pulse durations are measured for the optimal outputs (S_{gƒi fluid (EU@ RT)}, AMfexc, AMfrec, and AMoptgbh@RT), then an interpolation maybe done should the downhole pulse sequence vary from the measured pulse duration or frequencies. Where S_{gƒi fluid (EU@ RT)} is the value needed in engineering units EU to convert the reading from the NMR tool, S_{gƒi,@T}, into porosity units. S_{fi fluid (EU@ RT)} measured with water may be used directly. If a different fluid is used, S_{gƒi fluid (EU@ RT)} maybe be equal to:

$${S}_{gfi fluid ( EU @ RT )} = {S}_{fgi fluid measured ( EU @ RT )} \times HI \qquad ( Eq . 16 )$$

where S_{gƒi fluid measured (EU@ RT)} is the exact value in EU which was measured during the calibration and HI is the hydrogen index that is needed to make:

$${S}_{gfi fluid measured ( EU @ RT )} = 100 PU \qquad ( Eq . 17 )$$

Once all the calibration values from the lab or shop are determined, the tool 300 is ready to operate downhole. While downhole, the NMR tool 300 is operated to determine the frequency i at downhole temperature T where the measured signal at RT matches a theoretical RT signal according to:

$${S}_{gbhi @ RT} = {S}_{bhi , @ T , @ F} \times f ( T ) \qquad ( Eq . 14 )$$

$$where$$

$$f ( T ) = {T}_{log} / {T}_{RT} \qquad ( Eq . 15 )$$

S_{gbhi@RT} is the signal received by the tool 300 from measurements in the borehole sensitive volume as discussed above.

To do so, the NMR tool 300 may be operated in one of two optional modes to determine a downhole frequency ω_{gƒ@T} of the geometrically same formation sensitive volume that was measured in the lab at RT. In a first mode, where the NMR tool 300 has borehole measurement capabilities, the NMR tool 300 is operated to perform measurements in the borehole sensitive volume V_{bh} to find out at which downhole frequency:

$$A {0}_{gbh @ RT} = A {0}_{bhi , @ T , @ F} \times f ( T ) \qquad ( Eq . 18 )$$

The downhole frequency at which the above condition is met is ω_{gbh@T}. When this condition is met and effective borehole location and formation are close enough so the same g(T) can be used, then, through reciprocity,

$${ω}_{gf @ T} = ( 1 + g ( T ) \times Δ T ) \times {ω}_{gf @ RT} = {ω}_{gbh @ T} \times \frac{{ω}_{gf @ RT}}{{ω}_{gbh @ RT}} \qquad ( Eq . 19 )$$

where ω_{gƒ @T} is the downhole frequency of the geometrically same formation sensitive volume that was measured in the lab at RT.

To determine the downhole frequency, a sequence to collect data from the borehole frequencies is decided. This sequence might be the same one that was used during calibration, but it also could differ, as long as both measure A0 or total porosity. Sequence possibilities include but are not limited to a T1 sequence, a T2 sequence, or a porosity only sequence. The porosity only sequence will have an excitation −TE/2−(recovery−TE)n−TE/2−excitation (opposed phase). During the time of echo after the recovery pulse an echo is measured. This measurement can have only one repeat or it can have many. Data measured by the tool 300 from downhole might be processed in any manner to determine A0bh. For example, a linear fit might be used to determine A0 or an inversion may be performed. The motion of the volume might also be taken into account by doing a motion inclusive inversion.

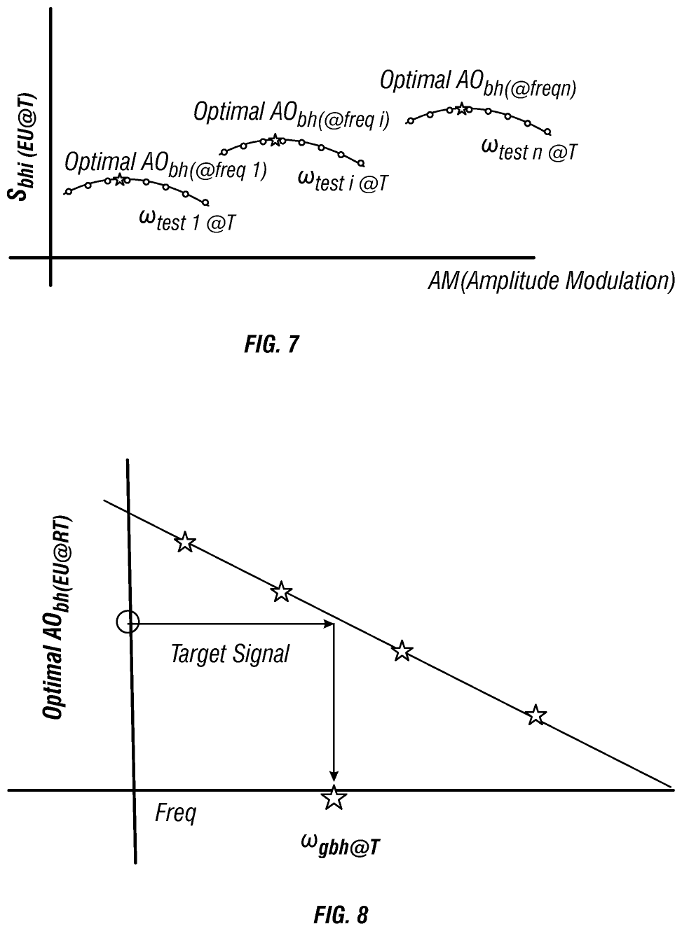

While downhole, the measurement frequency i for the borehole volume V_{bh} is varied as is the AM. The measured A0s at each frequency are then multiplied by ƒ(T). The best signal and the associated best A0 and AM are determined for each frequency. As shown in FIG. 7, the A0optbh is determined by calculating A0bh from the strongest signal S_{bhi(EU@T)} for each frequency. As shown in FIG. 8, a relationship is then determined with all of the optimal A0bh measurements between signal and frequency. This relationship might use a fitting such and a polynomial fitting, or it could use a more sophisticated fitting. The order or the fitting could be one which would be a linear fitting, or it could be of higher order. Most likely the preferred fitting will be a second order polynomial. Once the signal and frequency are fitted, A0_{gbhi@RT} is evaluated for the associated downhole borehole frequency ω_{gbh@T}.

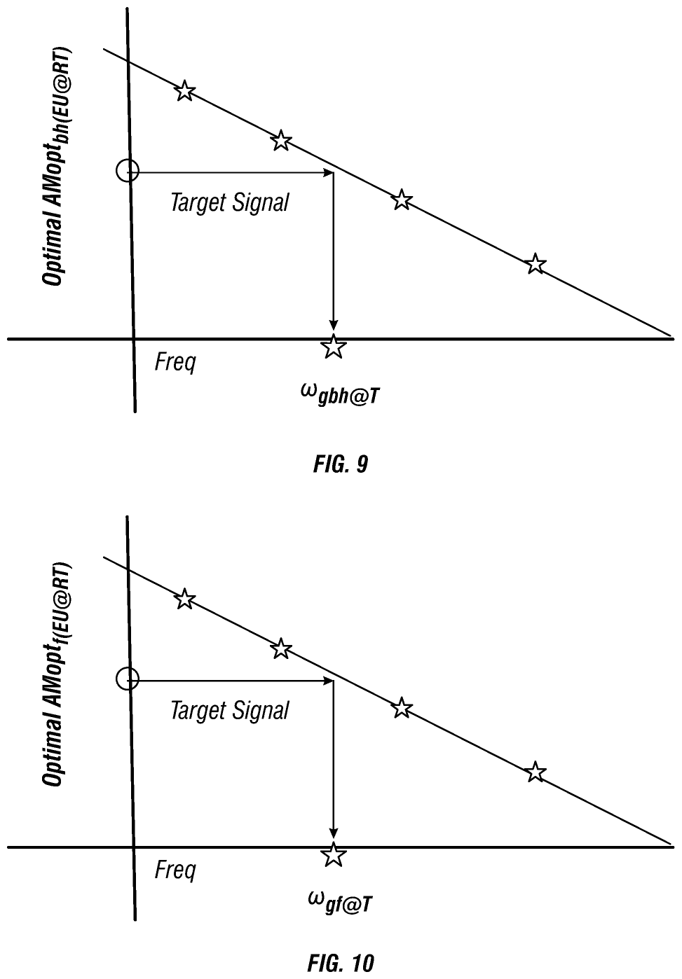

As shown in FIG. 9, a relationship is also determined with all of the AMoptbh measurements between AM and frequency. This relationship might use a fitting such and a polynomial fitting, or it could use a more sophisticated fitting. The order or the fitting could be one which would be a linear fitting, or it could be of higher order. Most likely the preferred fitting will be a second order polynomial. Once the signal and frequency are fitted, AMoptgbh@RT is evaluated for the associated downhole borehole frequency ω_{gbh@T}.

Once the downhole borehole frequency ω_{gbh@T} is determined, the field change fraction g(T) is then calculated according to:

$$g ( T ) = \frac{\frac{{ω}_{bhT}}{{ω}_{BhRT}} - 1}{Δ T} \qquad ( Eq . 20 )$$

Once g(T) is determined, the downhole formation frequency ω_{gƒ @T} associated with the downhole borehole frequency is then determined according to the equation:

$${ω}_{gf @ T} = ( 1 + g ( T ) \times Δ T ) \times {ω}_{gf @ RT} \qquad ( Eq . 19 )$$

Alternatively, ω_{gƒ @T} can be determined according to:

$${ω}_{gf @ T} = {ω}_{gbh @ T} \times \frac{{ω}_{gf @ RT}}{{ω}_{gbh @ RT}} , \qquad ( Eq . 19 )$$

As shown in FIG. 10, the optimal AM (“AMopt”) to use for ω_{gƒ @T} is also determined. To do so, the relationship between AMopt and the observed borehole frequencies is also determined similar to above using either a polynomial or other fitting method. The fitted data is then evaluated at a downhole frequency, ω_{gƒ @T}, to determine the optimal AM to use for that frequency in the formation. This process is repeated for each downhole frequency ω_{gƒ @T}. To do so, AMoptgbh@RT is assumed to equal AMoptgbh@T and AMoptgf@RT is assumed to equal AMoptgf@T. Optionally, an evaluation may be performed to determine whether the AMoptgbh@RT matches the AMoptgbh@T by comparing the AMoptgbh@T found by using signal magnitude matching instead of AM matching to find AMoptgbh@T.

In a second mode, where the NMR tool 300 does not have borehole measurement capabilities, the NMR tool 300 is operated to perform measurements in the formation sensitive volume V_{ƒ} to determine the downhole formation frequency ω_{gƒ @T} of the geometrically same formation sensitive volume that was measured in the lab at RT. To determine the downhole frequency, a sequence to collect data from the borehole frequencies is decided. This sequence might be the same one that was used during calibration, but it also could differ, as long as both measure A0 or total porosity. Sequence possibilities include but are not limited to a T1 sequence, a T2 sequence, or a porosity only sequence. The porosity only sequence will have an excitation −TE/2−(recovery−TE)n−TE/2−excitation (opposed phase). During the time of echo after the recovery pulse an echo is measured. This measurement can have only one repeat or it can have many. Data measured by the tool 300 from downhole might be processed in any manner to determine A0f. For example, a linear fit might be used to determine A0 or an inversion may be performed. The motion of the volume might also be taken into account by doing a motion inclusive inversion.

While downhole, measurements are taken while varying the measurement frequency i and the AM. The best signal and the associated best A0 and AM are determined for each frequency similarly as described above for the first mode. A relationship is then determined with all of the AMopt measurements between AM and frequency similarly as described above. This relationship might use a fitting such as a polynomial fitting, or it could use a more sophisticated fitting. The order or the fitting could be one which would be a linear fitting, or it could be of higher order. Most likely the preferred fitting will be a second order polynomial. As shown in FIG. 10, once the signal and frequency are fitted, AMoptgf@RT is evaluated for the associated downhole borehole frequency ω_{gƒ@T}.

Once the formation sensitive volume operational frequencies, ω_{gƒ @T}, and associated AMs are determined, the NMR tool 300 is then operated to produce an electromagnetic signal at those frequencies and AMs. The NMR tool 300 then receives a signal returned from the formation, S_{ƒi@T}. The received signal, which is in EU, is then conveyed to the information handling system 138 and converted to a reported signal, S_{reported}, is PU according to:

$${S}_{reported} = {S}_{fi @ T} \times \frac{100 PU}{{S}_{fi fluid ( EU @ RT )}} \times f ( T ) \qquad ( Eq . 21 )$$

Optionally, the received signal may be converted into a reported signal using a processor downhole in the NMR tool 300 or elsewhere in the BHA 134 before being communicated to the information handling system 138. The reported signal, S_{reported}, is then analyzed to determine a property or properties of the formation 104 such as pore size, porosity, porosity partitions, surface-to-volume ratio, formation permeability, fluid identification, and capillary pressure as examples. The information handling system 138 then produces a visual representation of the property or properties of the formation. For example, the information handling system displays the determined property or properties on the display of the user interface 160. Alternatively, the information handling system 138 may print the property or properties on a printer in communication with the information handling system 138.

Once the property or properties of the formation 104 are determined, additional action may be taken. For example, in the drilling system 100 of FIG. 1, a decision to stop drilling the borehole 16 or the decision to continue drilling the borehole may be made based on whether the location of the borehole is within a portion of the formation 104 appropriate for producing hydrocarbons. If the decision to stop drilling the borehole 16 is made, the drill string 8 and the drill bit 14 may be removed from the borehole 16 and the well may be completed for production. Further, the RSS 130 may be controlled to change the direction of the drill bit 14 and thus the direction of the borehole 16 based on one or more properties of the formation 104 determined by using the NMR tool 300. In this manner, the drill bit 14 may be “steered” based on the properties of the formation 104 measured during drilling, so so-called “geo-steering”.

In an alternative embodiment, to account for the temperature dependency of the NMR signal, a change in the sensitive volume due to the magnetic field gradient lowering as temperature rises is considered. In general, the “volume correction” method is similar to the “no volume correction” method. The difference is in how the temperature conversion function ƒ(T) is defined when used in the equation:

$${S}_{gbhi @ RT} = {S}_{bhi , @ T , @ F} \times f ( T ) \qquad ( Eq . 14 )$$

Here:

$$f ( T ) = {T}_{log} / {T}_{RT} \times {V}_{c} \qquad ( Eq . 22 )$$

where V_{c} is a corrective factor determined according to:

$${V}_{c} = {Factor}_{GeometryB 0} \times HI \qquad ( Eq . 23 )$$

where HI are the losses due to changes in density and pressure and can be determined in a lab. As discussed above, HI is the hydrogen index that is needed to make:

$${S}_{gfi fluid measured ( EU @ RT )} = 100 PU \qquad ( Eq . 24 )$$

If there is not determination of a HI relationship for temperature and pressure, HI can be set to one. Factor_{GeometryB0} is a factor representing the change of the sensitive volume geometrically at temperature at the same radial location. The Factor_{GeometryB0} can be determined in one of two ways, by performing an extension heated temperature calibration at least once with the NMR tool 300 or through modeling. If a temperature calibration is done the tank may have an oil in it which will not boil at temperatures above 150° C. (423.15 K). Modeling of the B₀ magnetic field can be done using any suitable modeling technique. For example, modeling the magnetic field and antenna field may be done using COMSOL MULTIPHYSICS®, ANSYS®, or any other suitable model to give a good representation of the magnetic and antenna fields. Once B₀ is modeled, the shape of the sensitive volume can be derived as a function of temperature, from which Factor_{GeometryB0} is derived. Once S_{gbhi@RT} is determined, S_{reported} can then be calculated using the methodologies discussed above.

Examples of the above embodiments include:

Example 1 is a method of performing a nuclear magnetic resonance (NMR) measurement of a subterranean formation from inside a borehole extending through the formation, comprising:
determining or selecting a calibration formation operational frequency (ω_{gƒ@RT}) for a calibration formation sensitive volume and a calibration borehole operational frequency (ω_{gbh@RT}) for a calibration borehole sensitive volume;
calibrating an NMR tool at ω_{gƒ@RT} to determine a signal received by the NMR tool at a calibration temperature (S_{gƒi(EU@ RT)}), an optimal excitation pulse amplitude modulation (AMfexc@RT), a recovery pulse amplitude modulation (AMfrec@RT) for ω_{gƒ@RT}, and an optimal formation amplitude modulation (AMoptf);
calibrating the NMR tool at ω_{gbh@RT} to determine a signal received by the NMR tool at a calibration temperature (S_{gbhi(EU@ RT)}), an excitation pulse amplitude modulation (AMbhexc@RT), a recovery pulse amplitude modulation (AMbhrec@RT), and an optimal borehole amplitude modulation (AMoptbh);
operating the NMR tool in the borehole at the formation at a downhole temperature to determine, in the downhole borehole sensitive volume, using a processor, a downhole borehole operational frequency (ω_{gbh@T}) at which the downhole borehole sensitive volume is substantially unchanged from the calibration borehole sensitive volume relative to the NMR tool;
determining, using the processor, a downhole formation operational frequency (ω_{gƒ@T}) at which the downhole formation sensitive volume is substantially unchanged from the calibration formation sensitive volume relative to the NMR tool based on ω_{gbh@T}, ω_{gbh@RT}, and ω_{gƒ@RT};
determining, using the processor, an optimal amplitude modulation (AMopt) for ω_{gƒ@T}; and
measuring a property of the formation using the NMR tool at ω_{gƒ@T} and AMopt.

In Example 2, the embodiments of any preceding paragraph or combination thereof further include, wherein determining ω_{gƒ@T} further comprises operating the NMR tool in the borehole at the formation at a downhole temperature to determine, in the downhole borehole sensitive volume, a ω_{gbh@T} at which the calibration echo signal amplitude at time zero (A0_{gbh@RT}) is the same as the product of a downhole echo signal amplitude at time zero (A0_{bhi,@T@F}) and a temperature conversion function (ƒ(T)) converting a signal at one temperature to another temperature.

In Example 3, the embodiments of any preceding paragraph or combination thereof further include, wherein ω_{gƒ@T} is determined based on ω_{gbh@T}, ω_{gbh@RT}, and ω_{gƒ@RT} according to:

$${ω}_{gf @ T} = {ω}_{gbh @ T} \times \frac{{ω}_{gf @ RT}}{{ω}_{gbh @ RT}} .$$

In Example 4, the embodiments of any preceding paragraph or combination thereof further include, wherein determining ω_{gbh@T} further comprises accounting for a change in the downhole borehole sensitive volume based on a change in a magnetic gradient of the downhole borehole sensitive volume due to a temperature of the formation.

In Example 5, the embodiments of any preceding paragraph or combination thereof further include, wherein determining ω_{gƒ@T} further comprises operating the NMR tool in the borehole at the formation at a downhole temperature to determine, in the downhole borehole sensitive volume, a ω_{gbh@T} at which an optimal excitation amplitude modulation (AMbhexc@T) is equal to AMbhexc@RT, and an optimal recovery amplitude modulation (AMbhrec@T) is equal to AMbhrec@RT.

In Example 6, the embodiments of any preceding paragraph or combination thereof further include, wherein determining ω_{gbh@T} further comprises accounting for a change in a radio frequency (RF) pulse due to a change in downhole temperature.

In Example 7, the embodiments of any preceding paragraph or combination thereof further include, wherein measuring the property comprises receiving a signal with the NMR tool from the formation sensitive volume downhole, S_{ƒi,@T}, in engineering units (EU) and, using a processor, converting the signal to a reported signal, S_{reported}, in porosity units (PU) according to:

$${S}_{reported} = {S}_{fi , @ T} \times \frac{100 PU}{{S}_{fi fluid ( EU @ RT )}} \times f ( T ) ,$$

where S_{fi fluid (EU@ RT)} is the signal received by the NMR tool from the formation sensitive volume during calibration and ƒ(T) is a temperature conversion function.

In Example 8, the embodiments of any preceding paragraph or combination thereof further include controlling a drill bit to drill the borehole based on the measured property of the formation.

Example 9 is a nuclear magnetic resonance (NMR) system for measurement of a property of a subterranean formation from a borehole extending through the formation, comprising:
an NMR tool comprising a magnet, an antenna operable to emit an electromagnetic signal, and an antenna operable to receive an electromagnetic signal based on the emitted electromagnetic signal; and
an information handling system comprising a processor and in data communication with the NMR tool,
wherein the NMR tool is calibrated at a calibration formation operational frequency (ω_{gƒ@RT}) for a calibration formation sensitive volume to determine a signal received by the NMR tool at a calibration temperature (S_{gƒi(EU@RT)}), an excitation amplitude modulation (AMfexc @RT), and a recovery amplitude modulation (AMfrec@RT) for ω_{gƒ@RT};
wherein the NMR tool is calibrated at a calibration borehole operational frequency (ω_{gbh@RT}) for a calibration borehole sensitive volume to determine a signal received by the NMR tool at a calibration temperature (S_{gbhi(EU@ RT)}), excitation amplitude modulation (AMbhexc@RT), a recovery amplitude modulation (AMbhrec@RT), and a calibration echo signal amplitude at time zero (A0_{gbh@RT}) for ω_{gbh@RT};
wherein the NMR tool is operable downhole in the borehole at the formation at a downhole temperature to determine, in the downhole borehole sensitive volume, using the processor, a downhole borehole operational frequency (ω_{gbh@T}) at which the downhole borehole sensitive volume is substantially unchanged from the calibration borehole sensitive volume relative to the NMR tool;
wherein the processor is operable to determine a downhole formation operational frequency (ω_{gƒ@T}) at which the downhole formation sensitive volume is substantially unchanged from the calibration formation sensitive volume relative to the NMR tool based on ω_{gbh@T}, ω_{gbh@RT}, and ω_{gƒ@RT};
wherein the processor is operable to determine an optimal amplitude modulation (AMopt) for ω_{gƒ@T}; and
wherein the NMR tool is operable to measure a property of the formation by emitting an electromagnetic signal at ω_{gƒ@T} and AMopt.

In Example 10, the embodiments of any preceding paragraph or combination thereof further include, wherein the NMR tool is operable in the borehole at the formation at a downhole temperature and the processor is operable to determine, in the downhole borehole sensitive volume, a ω_{gbh@T} at which the calibration echo signal amplitude at time zero (A0_{gbh@RT}) is the same as the product of a downhole echo signal amplitude at time zero (A0_{bhi,@T@F}) and a temperature conversion function (ƒ(T)) converting a signal at one temperature to another temperature to determine ω_{gƒ@T}.

In Example 11, the embodiments of any preceding paragraph or combination thereof further include, wherein the processor is operable to determine ω_{gƒ@T} based on ω_{gbh@T}, ω_{gbh@RT}, and ω_{gƒ@RT} according to:

$${ω}_{gf @ T} = {ω}_{gbh @ T} \times \frac{{ω}_{gf @ RT}}{{ω}_{gbh @ RT}} .$$

In Example 12, the embodiments of any preceding paragraph or combination thereof further include, wherein the processor is operable to determine ω_{gbh@T} by accounting for a change in the downhole borehole sensitive volume based on a change in a magnetic gradient of the downhole borehole sensitive volume due to a temperature of the formation.

In Example 13, the embodiments of any preceding paragraph or combination thereof further include, wherein the processor is operable to determine the change in the downhole borehole sensitive volume based on:

$${V}_{c} = {Factor}_{GeometryB 0} \times HI ,$$

where V_{c} is a corrective factor, Factor_{GeometryB0} is a factor representing the change of the sensitive volume geometrically at temperature at the same radial location, and HI is a hydrogen index.

In Example 14, the embodiments of any preceding paragraph or combination thereof further include, wherein the NMR tool is operable in the borehole at the formation at a downhole temperature and the processor is operable to determine, in the downhole borehole sensitive volume, a ω_{gbh@T} at which an optimal excitation amplitude modulation (AMbhexc@T) is equal to AMbhexc@RT, and an optimal recovery amplitude modulation (AMbhrec@T) is equal to AMbh180@RT.

In Example 15, the embodiments of any preceding paragraph or combination thereof further include, wherein the processor is operable to determine ω_{gbh@T} by accounting for a change in a radio frequency (RF) pulse due to a change in downhole temperature.

In Example 16, the embodiments of any preceding paragraph or combination thereof further include, wherein the NMR tool being operation to measure the property further comprises the NMR tool being operable to receive a signal from the formation sensitive volume downhole, S_{ƒi,@T}, in engineering units (EU) and, the processor is further operable to convert the signal to a reported signal, S_{reported}, in porosity units (PU) according to:

$${S}_{reported} = {S}_{fi , @ T} \times \frac{100 PU}{{S}_{fi fluid ( EU @ RT )}} \times f ( T ) ,$$

where S_{ƒi fluid (EU@ RT)} is the signal received by the NMR tool from the formation sensitive volume during calibration and ƒ(T) is a temperature conversion function.

In Example 17, the embodiments of any preceding paragraph or combination thereof further include a drill bit operable to drill the borehole, wherein the processor is further operable to control the drill bit to drill the borehole based on the measured property of the formation.

Example 18 is a method of drilling a borehole through a subterranean formation, comprising:
determining or selecting a calibration formation operational frequency (ω_{gƒ@RT}) for a calibration formation sensitive volume and a calibration borehole operational frequency (ω_{gbh@RT}) for a calibration borehole sensitive volume;
calibrating an NMR tool at ω_{gƒ@RT} to determine a signal received by the NMR tool at a calibration temperature (S_{gƒi(EU@ RT)}), an excitation amplitude modulation (AMfexc@RT), and a recovery amplitude modulation (AMfrec@RT) for ω_{gƒ@RT};
calibrating the NMR tool at ω_{gbh@RT} to determine a signal received by the NMR tool at a calibration temperature (S_{gbhi(EU@ RT)}), an excitation amplitude modulation (AMbhexc@RT), a recovery amplitude modulation (AMbhrec@RT), and a calibration echo signal amplitude at time zero (A0_{gbh@RT}) for ω_{gbh@RT};
operating the NMR tool in the borehole at the formation at a downhole temperature to determine, in the downhole borehole sensitive volume, using a processor, a downhole borehole operational frequency (ω_{gbh@T}) at which the downhole borehole sensitive volume is substantially unchanged from the calibration borehole sensitive volume relative to the NMR tool;
operating the NMR tool in the borehole at the formation at a downhole temperature to determine, in the downhole borehole sensitive volume, using a processor, a ω_{gbh@T} at which an optimal excitation amplitude modulation (AMbhexc@T) is equal to AMbhexc@RT, and an optimal recovery amplitude modulation (AMbhrec@T) is equal to AMbhrec@RT;
determining, using the processor, a downhole formation operational frequency (ω_{gƒ@T}) at which the downhole formation sensitive volume is substantially unchanged from the calibration formation sensitive volume relative to the NMR tool based on ω_{gbh@T}, ω_{gbh@RT}, and ω_{gƒ@RT};
determining, using the processor, an optimal amplitude (AMopt) for ω_{gƒ@T};
measuring a property of the formation using the NMR tool at ω_{gƒ@T} and AMopt; and
controlling a drill bit to drill the borehole based on the measured property of the formation.

In Example 19, the embodiments of any preceding paragraph or combination thereof further include, wherein determining the downhole formation operational frequency (ω_{gƒ@T}) further comprises operating the NMR tool in the borehole at the formation at a downhole temperature to determine, in the downhole borehole sensitive volume, a downhole borehole operational frequency (ω_{gbh@T}) at which the calibration echo signal amplitude at time zero (A0_{gbh@RT}) is the same as the product of a downhole echo signal amplitude at time zero (A0_{bhi,@T@F}) and a temperature conversion function (ƒ(T)) converting a signal at one temperature to another temperature.

In Example 20, the embodiments of any preceding paragraph or combination thereof further include, wherein ω_{gƒ@T} is determined based on ω_{gbh@T}, ω_{gbh@RT}, and ω_{gƒ@RT} according to:

$${ω}_{gf @ T} = {ω}_{gbh @ T} \times \frac{{ω}_{gf @ RT}}{{ω}_{gbh @ RT}} .$$

In Example 21, the embodiments of any preceding paragraph or combination thereof further include, wherein determining ω_{gbh@T} further comprises accounting for a change in the downhole borehole sensitive volume based on a change in a magnetic gradient of the downhole borehole sensitive volume due to a temperature of the formation.

In Example 22, the embodiments of any preceding paragraph or combination thereof further include, wherein determining ω_{gbh@T} further comprises accounting for a change in a radio frequency (RF) pulse due to a change in downhole temperature.

In Example 23, the embodiments of any preceding paragraph or combination thereof further include, wherein measuring the property comprises receiving a signal with the NMR tool from the formation sensitive volume downhole, S_{ƒi,@T}, in engineering units (EU) and, using a processor, converting the signal to a reported signal, S_{reported}, in porosity units (PU) according to:

$${S}_{reported} = {S}_{fi , @ T} \times \frac{100 PU}{{S}_{fi fluid ( EU @ RT )}} \times f ( T ) ,$$

where S_{ƒi fluid (EU@ RT)} is the signal received by the NMR tool from the formation sensitive volume during calibration and ƒ(T) is a temperature conversion function.

Certain terms are used throughout the description and claims to refer to particular features or components. As one skilled in the art will appreciate, different persons may refer to the same feature or component by different names. This document does not intend to distinguish between components or features that differ in name but not function.

For the embodiments and examples above, a non-transitory computer readable medium can comprise instructions stored thereon, which, when performed by a machine, cause the machine to perform operations, the operations comprising one or more features similar or identical to features of methods and techniques described above. The physical structures of such instructions may be operated on by one or more processors. A system to implement the described algorithm may also include an electronic apparatus and a communications unit. The system may also include a bus, where the bus provides electrical conductivity among the components of the system. The bus can include an address bus, a data bus, and a control bus, each independently configured. The bus can also use common conductive lines for providing one or more of address, data, or control, the use of which can be regulated by the one or more processors. The bus can be configured such that the components of the system can be distributed. The bus may also be arranged as part of a communication network allowing communication with control sites situated remotely from system.

In various embodiments of the system, peripheral devices such as displays, additional storage memory, and/or other control devices that may operate in conjunction with the one or more processors and/or the memory modules. The peripheral devices can be arranged to operate in conjunction with display unit(s) with instructions stored in the memory module to implement the user interface to manage the display of information. Such a user interface can be operated in conjunction with the communications unit and the bus. Various components of the system can be integrated such that processing identical to or similar to the processing schemes discussed with respect to various embodiments herein can be performed.

While descriptions herein may relate to “comprising” various components or steps, the descriptions can also “consist essentially of” or “consist of” the various components and steps.

Unless otherwise indicated, all numbers expressing quantities are to be understood as being modified in all instances by the term “about” or “approximately”. Accordingly, unless indicated to the contrary, the numerical parameters are approximations that may vary depending upon the desired properties of the present disclosure. As used herein, “about”, “approximately”, “substantially”, and “significantly” will be understood by persons of ordinary skill in the art and will vary to some extent on the context in which they are used. If there are uses of the term which are not clear to persons of ordinary skill in the art given the context in which it is used, “about” and “approximately” will mean plus or minus 10% of the particular term and “substantially” and “significantly” will mean plus or minus 5% of the particular term.

The embodiments disclosed should not be interpreted, or otherwise used, as limiting the scope of the disclosure, including the claims. It is to be fully recognized that the different teachings of the embodiments discussed may be employed separately or in any suitable combination to produce desired results. In addition, one skilled in the art will understand that the description has broad application, and the discussion of any embodiment is meant only to be exemplary of that embodiment, and not intended to suggest that the scope of the disclosure, including the claims, is limited to that embodiment.

What is claimed is:

1. A method of performing a nuclear magnetic resonance (NMR) measurement of a subterranean formation from inside a borehole extending through the formation, comprising:
determining or selecting a calibration formation operational frequency (ω_{gƒ@RT}) for a calibration formation sensitive volume and a calibration borehole operational frequency (ω_{gbh@RT}) for a calibration borehole sensitive volume;
calibrating an NMR tool at ω_{gƒ@RT} to determine a signal received by the NMR tool at a calibration temperature (S_{gƒi ω(EU@ RT)}), an optimal excitation pulse amplitude modulation (AMfexc@RT), a recovery pulse amplitude modulation (AMfrec@RT) for ω_{gƒ@RT}, and an optimal formation amplitude modulation (AMoptf);
calibrating the NMR tool at ω_{gbh@RT} to determine a signal received by the NMR tool at a calibration temperature (S_{gbhi(EU@ RT)}), an excitation pulse amplitude modulation (AMbhexc@RT), a recovery pulse amplitude modulation (AMbhrec@RT), and an optimal borehole amplitude modulation (AMoptbh);
operating the NMR tool in the borehole at the formation at a downhole temperature to determine, in the downhole borehole sensitive volume, using a processor, a downhole borehole operational frequency (ω_{gbh@T}) at which the downhole borehole sensitive volume is substantially unchanged from the calibration borehole sensitive volume relative to the NMR tool;
determining, using the processor, a downhole formation operational frequency (ω_{gƒ@T}) at which the downhole formation sensitive volume is substantially unchanged from the calibration formation sensitive volume relative to the NMR tool based on ω_{gbh@T}, ω_{gbh@RT}, and ω_{gƒ@RT};
determining, using the processor, an optimal amplitude modulation (AMopt) for ω_{gƒ@T}; and
measuring a property of the formation using the NMR tool at ω_{gƒ@T} and AMopt.

2. The method of claim 1, wherein determining ω_{gƒ@T} or further comprises operating the NMR tool in the borehole at the formation at a downhole temperature to determine, in the downhole borehole sensitive volume, a ω_{gbh@T} at which the calibration echo signal amplitude at time zero (A0_{gbh@RT}) is the same as the product of a downhole echo signal amplitude at time zero (A0_{bhi,@T@F}) and a temperature conversion function (ƒ(T)) converting a signal at one temperature to another temperature.

3. The method of claim 2, wherein ω_{gƒ@T} is determined based on ω_{gbh@T}, ω_{gbh@RT}, and ω_{gƒ@RT} according to:
$${ω}_{gf @ T} = {ω}_{gbh @ T} \times \frac{{ω}_{gf @ RT}}{{ω}_{gbh @ RT}} .$$

4. The method of claim 2, wherein determining ω_{gbh@T} further comprises accounting for a change in the downhole borehole sensitive volume based on a change in a magnetic gradient of the downhole borehole sensitive volume due to a temperature of the formation.

5. The method of claim 1, wherein determining ω^{gƒ@T} or further comprises operating the NMR tool in the borehole at the formation at a downhole temperature to determine, in the downhole borehole sensitive volume, a ω_{gbh@T} at which an optimal excitation amplitude modulation (AMbhexc@T) is equal to AMbhexc@RT, and an optimal recovery amplitude modulation (AMbhrec@T) is equal to AMbhrec@RT.

6. The method of claim 1, wherein determining ω_{gbh@T} further comprises accounting for a change in a radio frequency (RF) pulse due to a change in downhole temperature.

7. The method of claim 1, wherein measuring the property comprises receiving a signal with the NMR tool from the formation sensitive volume downhole, S_{ƒi,@T}, in engineering units (EU) and, using a processor, converting the signal to a reported signal, S_{reported}, in porosity units (PU) according to:
$${S}_{reported} = {S}_{fi , @ T} \times \frac{100 PU}{{S}_{fi fluid ( EU @ RT )}} \times f ( T ) ,$$
where S_{ƒi fluid (EU@ RT)} is the signal received by the NMR tool from the formation sensitive volume during calibration and ƒ(T) is a temperature conversion function.

8. The method of claim 1, further comprising controlling a drill bit to drill the borehole based on the measured property of the formation.

9. A nuclear magnetic resonance (NMR) system for measurement of a property of a subterranean formation from a borehole extending through the formation, comprising:
an NMR tool comprising a magnet, an antenna operable to emit an electromagnetic signal, and an antenna operable to receive an electromagnetic signal based on the emitted electromagnetic signal; and
an information handling system comprising a processor and in data communication with the NMR tool,
wherein the NMR tool is calibrated at a calibration formation operational frequency (ω_{gƒ@RT}) for a calibration formation sensitive volume to determine a signal received by the NMR tool at a calibration temperature (S_{gƒi(EU@ RT)}), an excitation amplitude modulation (AMfexc@RT), and a recovery amplitude modulation (AMfrec@RT) for ω_{gƒ@RT};
wherein the NMR tool is calibrated at a calibration borehole operational frequency (ω_{gbh@RT}) for a calibration borehole sensitive volume to determine a signal received by the NMR tool at a calibration temperature (S_{gbhi(EU@ RT)}), excitation amplitude modulation (AMbhexc@RT), a recovery amplitude modulation (AMbhrec@RT), and a calibration echo signal amplitude at time zero (A0_{gbh@RT}) for ω_{gbh@RT};
wherein the NMR tool is operable downhole in the borehole at the formation at a downhole temperature to determine, in the downhole borehole sensitive volume, using the processor, a downhole borehole operational frequency (ω_{gbh@T}) at which the downhole borehole sensitive volume is substantially unchanged from the calibration borehole sensitive volume relative to the NMR tool;
wherein the processor is operable to determine a downhole formation operational frequency (ω_{gƒ@T}) at which the downhole formation sensitive volume is substantially unchanged from the calibration formation sensitive volume relative to the NMR tool based on ω_{gbh@T}, ω_{gbh@RT}, and ω_{gƒ@RT};
wherein the processor is operable to determine an optimal amplitude modulation (AMopt) for ω_{gƒ@T}; and
wherein the NMR tool is operable to measure a property of the formation by emitting an electromagnetic signal at ω_{gƒ@T} and AMopt.

10. The system of claim 9, wherein the NMR tool is operable in the borehole at the formation at a downhole temperature and the processor is operable to determine, in the downhole borehole sensitive volume, a ω_{gbh@T} at which the calibration echo signal amplitude at time zero (A0_{gbh@RT}) is the same as the product of a downhole echo signal amplitude at time zero (A0_{bhi,@T@F}) and a temperature conversion function (ƒ(T)) converting a signal at one temperature to another temperature to determine ω_{gƒ@T}.

11. The system of claim 10, wherein the processor is operable to determine ω_{gƒ@T} based on ω_{gbh@T}, ω_{gbh@RT}, and ω_{gƒ@RT} according to:
$${ω}_{gf @ T} = {ω}_{gbh @ T} \times \frac{{ω}_{gf @ RT}}{{ω}_{gbh @ RT}} .$$

12. The system of claim 10, wherein the processor is operable to determine ω_{gbh@T} by accounting for a change in the downhole borehole sensitive volume based on a change in a magnetic gradient of the downhole borehole sensitive volume due to a temperature of the formation.

13. The system of claim 12, wherein the processor is operable to determine the change in the downhole borehole sensitive volume based on:
$${V}_{c} = {Factor}_{GeometryB 0} \times HI ,$$
where V_{c} is a corrective factor, Factor_{GeometryB0} is a factor representing the change of the sensitive volume geometrically at temperature at the same radial location, and HI is a hydrogen index.

14. The system of claim 9, wherein the NMR tool is operable in the borehole at the formation at a downhole temperature and the processor is operable to determine, in the downhole borehole sensitive volume, a ω_{gbh@T} at which an optimal excitation amplitude modulation (AMbhexc@T) is equal to AMbhexc@RT, and an optimal recovery amplitude modulation (AMbhrec@T) is equal to AMbh180@RT.

15. The system of claim 9, wherein the processor is operable to determine ω_{gbh@T} by accounting for a change in a radio frequency (RF) pulse due to a change in downhole temperature.

16. The system of claim 9, wherein the NMR tool being operation to measure the property further comprises the NMR tool being operable to receive a signal from the formation sensitive volume downhole, S_{ƒi,@T}, in engineering units (EU) and, the processor is further operable to convert the signal to a reported signal, S_{reported}, in porosity units (PU) according to:
$${S}_{reported} = {S}_{fi , @ T} \times \frac{100 PU}{{S}_{fi fluid ( EU @ RT )}} \times f ( T ) ,$$
where S_{ƒi fluid (EU@ RT)} is the signal received by the NMR tool from the formation sensitive volume during calibration and ƒ(T) is a temperature conversion function.

17. The system of claim 9 further comprising a drill bit operable to drill the borehole, wherein the processor is further operable to control the drill bit to drill the borehole based on the measured property of the formation.

18. A method of drilling a borehole through a subterranean formation, comprising:
determining or selecting a calibration formation operational frequency (ω_{gƒ@RT}) for a calibration formation sensitive volume and a calibration borehole operational frequency (ω_{gbh@RT}) for a calibration borehole sensitive volume;
calibrating an NMR tool at ω_{gƒ@RT} to determine a signal received by the NMR tool at a calibration temperature (S_{gƒi(EU@ RT)}), an excitation amplitude modulation (AMfexc@RT), and a recovery amplitude modulation (AMfrec@RT) for ω_{gƒ@RT};
calibrating the NMR tool at ω_{gbh@RT} to determine a signal received by the NMR tool at a calibration temperature (S_{gbhi(EU@ RT)}), an excitation amplitude modulation (AMbhexc@RT), a recovery amplitude modulation (AMbhrec@RT), and a calibration echo signal amplitude at time zero (A0_{gbh@RT}) for ω_{gbh@RT};
operating the NMR tool in the borehole at the formation at a downhole temperature to determine, in the downhole borehole sensitive volume, using a processor, a downhole borehole operational frequency (ω_{gbh@T}) at which the downhole borehole sensitive volume is substantially unchanged from the calibration borehole sensitive volume relative to the NMR tool;
operating the NMR tool in the borehole at the formation at a downhole temperature to determine, in the downhole borehole sensitive volume, using a processor, a ω_{gbh@T} at which an optimal excitation amplitude modulation (AMbhexc@T) is equal to AMbhexc@RT, and an optimal recovery amplitude modulation (AMbhrec@T) is equal to AMbhrec@RT;
determining, using the processor, a downhole formation operational frequency (ω_{gƒ@T}) at which the downhole formation sensitive volume is substantially unchanged from the calibration formation sensitive volume relative to the NMR tool based on ω_{gbh@T}, ω_{gbh@RT}, and ω_{gƒ@RT};
determining, using the processor, an optimal amplitude (AMopt) for ω_{gƒ@T};
measuring a property of the formation using the NMR tool at ω_{gƒ@T} or and AMopt; and
controlling a drill bit to drill the borehole based on the measured property of the formation.

19. The method of claim 18, wherein determining the downhole formation operational frequency (ω_{gƒ@T}) further comprises operating the NMR tool in the borehole at the formation at a downhole temperature to determine, in the downhole borehole sensitive volume, a downhole borehole operational frequency (ω_{gbh@T}) at which the calibration echo signal amplitude at time zero (A0_{gbh@RT}) is the same as the product of a downhole echo signal amplitude at time zero (A0_{bhi,@T@F}) and a temperature conversion function (ƒ(T)) converting a signal at one temperature to another temperature.

20. The method of claim 19, wherein ω_{gƒ@T} or is determined based on ω_{gbh@T}, ω_{gbh@RT}, and ω_{gƒ@RT} according to:
$${ω}_{gf @ T} = {ω}_{gbh @ T} \times \frac{{ω}_{gf @ RT}}{{ω}_{gbh @ RT}} .$$

21. The method of claim 19, wherein determining ω_{gbh@T} further comprises accounting for a change in the downhole borehole sensitive volume based on a change in a magnetic gradient of the downhole borehole sensitive volume due to a temperature of the formation.

22. The method of claim 18, wherein determining ω_{gbh@T} further comprises accounting for a change in a radio frequency (RF) pulse due to a change in downhole temperature.

23. The method of claim 18, wherein measuring the property comprises receiving a signal with the NMR tool from the formation sensitive volume downhole, S_{ƒi,@T}, in engineering units (EU) and, using a processor, converting the signal to a reported signal, S_{reported}, in porosity units (PU) according to:
$${S}_{reported} = {S}_{fi , @ T} \times \frac{100 PU}{{S}_{fi fluid ( EU @ RT )}} \times f ( T ) ,$$
where S_{ƒi fluid (EU@ RT)} is the signal received by the NMR tool from the formation sensitive volume during calibration and ƒ(T) is a temperature conversion function.
